(19) United States
(12) Patent Application Publication
(10) Pub. No.: US 2012/0024118 A1
(43) Pub. Date: Feb. 2, 2012

(54) Magnetic hinge tool

(76) Inventor: Timothy Mullenix, St. Helens, OR (US)

(21) Appl. No.: 12/804,639

(22) Filed: Jul. 27, 2010

(51) Int. Cl. B25B 33/00

(52) U.S. Cl. 81/486

(57) ABSTRACT

A tool for compressing a safety interlock switch on appliances is disclosed. The tool comprises of a first portion having an upper end and a lower end and a second portion connected to the first portion by a hinge means. At least one magnet may be secured to the first portion and at least one ferrous portion may be integrated within the second portion. The at least one magnet may be configured to fixedly contact with a smooth metal surface of the appliance while compressing the safety interlock switch with the second portion thereby enabling technicians to safely diagnose, maintain, and repair the appliances. The tool prevents the inadvertent disablement of the switch by mechanically blocking a door of the appliance from closing. The tool can be easily opened with one hand, fits easily in a pocket and prevents unwanted attraction of ferrous objects in the closed position.

### BACKGROUND OF THE INVENTION

1. Technical Field of the Invention

The present invention relates in general to a tool utilized for servicing an appliance. More specifically, the present invention relates to a tool utilized to compress safety interlock switches commonly found on appliances.

2. Description of the Related Art

Many home and commercial appliances present a silent danger mainly electric shock during maintenance and repair. The repair technician cannot identify it beforehand, but if electricity jolts through the body, the pain is not forgotten, and the injury to person can be lasting if not deadly.

Electrical appliances such as dryers, HVAC units, and the like are well known in the art and understood to be commonplace in industrial and residential applications. The common appliance configuration includes a door or panel and mechanically interacts with a safety interlock switch. The switch is compressed when the access door or panel is in the closed position the appliance is “hot” or electrically powered. When the access door or panel is opened, the switch is decompressed. In the decompressed position the switch shuts off the electrical power to the appliance for safety, and to avoid electrical shock. For a dryer, the interlock switch goes to open when the door is open thereby disabling the electrical power while wet clothes are put in the tumbler thereby preventing the dryer from starting when the door is open. For an HVAC unit, the access panel or door has a safety interlock switch that shuts down all power within the unit when the panel or door is open.

When the safety interlock switch is open, a trained professional would be unable to test the electrical components without electrical power to the appliance. Common methods used by technicians for circumventing the purpose of the switch is to tape over it or jam a small knife blade into the switch forcing it to remain in the closed position while performing diagnosis. The circumvention of the switch reconnects the electrical power to the appliance facilitating hot testing and diagnosis. However, technicians often forget to remove the tape from the switch after the maintenance or repair is complete. The access door is closed over the tape and the switch is disabled, creating dangerous circumstances for the homeowner.

Most conventional HVAC units utilize a switching system to control various functions of the HVAC system including the safety interlock switch. This switching system could be complicated in accordance with its operation and construction. The technician may also use a lock-out device which works with a safety interlock switch to shut off the electricity and pneumatic power system during maintenance. Such a lock-out device can be cumbersome and too large to fit into a pocket. Another drawback of interlock tools is that the mechanism requires the technician to use both hands to operate it.

Therefore, as can be appreciated, there is a need for a simple tool utilized for compressing a safety interlock switch on an appliance to provide power ‘on’ diagnostic and repair work. Such a needed tool would be removably engageable on the appliance and small enough to fit easily in a pocket. Further, the tool would enable the technician to easily operate it with one hand. The tool would be simple in construction and economical in price.

### SUMMARY OF THE INVENTION

To minimize the limitations found in the prior art, and to minimize other limitations that will be apparent upon the reading of the specifications, the present invention provides a tool for compressing a safety interlock switch on appliances such as Heating and Air Conditioning (HVAC) units, dryers, water coolers, and some gas heaters. The tool comprises of a first portion having an upper end and a lower end and a second portion connected to the first portion by a hinge means. At least one magnet may be secured to the first portion and at least one ferrous portion may be integrated within the second portion. The at least one magnet may be configured to fixedly contact with a smooth metal surface of the appliance while compressing the safety interlock switch with the second portion. A spacer of desired thickness may be secured to the at least one ferrous portion by a spacer magnet to provide maximum compression of the safety interlock switch. A notch may be provided on the upper end of the first portion to allow for easy one hand opening of the tool.

The first portion and the second portion may be overlaid with a layer of material selected from a group consisting of soft rubber and silicone. This layer of material prevents ferrous objects from getting between the first portion and the second portion in the closed position. The layer of material on the first portion encases all sides of the at least one magnet leaving only one flat side exposed. The exposed flat side may be layered with a material selected from a group consisting of soft rubber and silicone to provide a more secure grip to the smooth metal surface of the appliance. The tool is removable engageable with the smooth metal surface and fits easily in a technician's pocket.

One objective of the invention is to provide a tool capable of enabling technicians and repair specialist to safely diagnose, maintain, and repair appliances commonly found in the home.

Another objective of the invention is to provide a tool capable of being opened with one hand and that secures to and compresses a safety interlock switch on the appliance, thereby providing power on diagnostic and repair work.

A third objective of the invention is to provide a tool capable of allowing safe “hot” diagnostic and repair, while preventing the inadvertent disablement of the safety interlock switch after the technician leaves.

Another objective of the invention is to provide a tool having a hinge means that allows for motion of the tool from a closed position to an open position allowing for compact storage and quick application.

Another objective of the invention is to provide a tool that can replace the large and cumbersome lock-out device.

Yet another objective of the invention is to provide a tool having at least one magnet being encased in non-conductive material on all sides but one, thereby preventing the unwanted attraction of screws, nails, and/or other ferrous objects when the tool is in the closed position.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a perspective view of the present invention, illustrating a tool for compressing a safety interlock switch on an appliance in an open position;

FIG. 2 is a perspective view of the present invention, illustrating a hinge means utilized for connecting a first portion and a second portion;

FIG. 3 is a bottom plan view of the second portion of the present invention;

FIG. 4 is a perspective view of the tool in a partially open position, illustrating a notch on an upper end of the first portion and at least one ferrous portion on the second portion;

FIG. 5a is an exploded view of the present invention, illustrating a layer of material overlaying the first portion and the second portion;

FIG. 5b is an exploded view of the present invention in a partially open position, illustrating at least one magnet completely encased by the layer of material;

FIG. 6 is an enlarged view of the first portion of the present invention, illustrating the at least one magnet and the notch on the upper end;

FIG. 7 is a top perspective view of the present invention;

FIG. 8 is a perspective view of the present invention, illustrating a spacer secured to the second portion;

FIG. 9a is a perspective view of a dryer with a safety interlock switch associated with the present invention;

FIG. 9b is a perspective view of the present invention in use with the dryer, illustrating the safety interlock switch and the tool magnetically attached onto the dryer;

FIG. 9c is a perspective view of the present invention in use with the dryer, illustrating the compression of the safety interlock switch with the tool by means of the spacer;

FIG. 10a is a perspective view of a water cooler with a safety interlock switch associated with the present invention; and

FIG. 10b is a perspective view of the present invention in use with the water cooler, illustrating the compression of the safety interlock switch with the tool by means of the spacer.

### DETAILED DESCRIPTION OF THE DRAWINGS

In the following discussion that addresses a number of embodiments and applications of the present invention, reference is made to the accompanying drawings that form a part of hereof, and in which is shown by way of illustration specific embodiments in which the invention may be practiced. It is to be understood that other embodiments may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

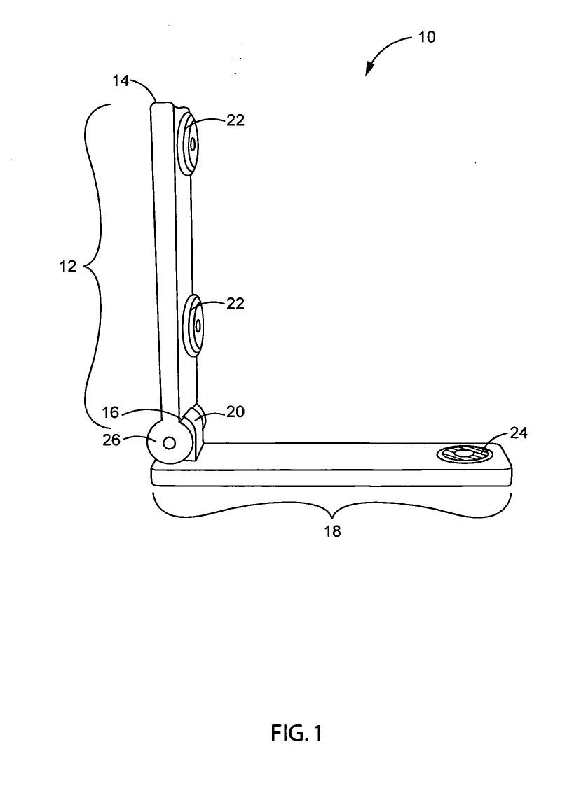

FIG. 1 is a perspective view of a tool 10 utilized for compressing a safety interlock switch (not shown) on appliances such as Heating and Air Conditioning (HVAC) units, dryers, water coolers, and some gas heaters. The tool 10 comprises of a first portion 12 having an upper end 14 and a lower end 16 and a second portion 18 connected to the first portion 12 by a hinge means 20. At least one magnet 22 may be secured to the first portion 12 and at least one ferrous portion 24 may be integrated within the second portion 18. The at least one magnet 22 may be configured to fixedly contact with a smooth metal surface of the appliance (not shown) while compressing the safety interlock switch (not shown) with the second portion 18.

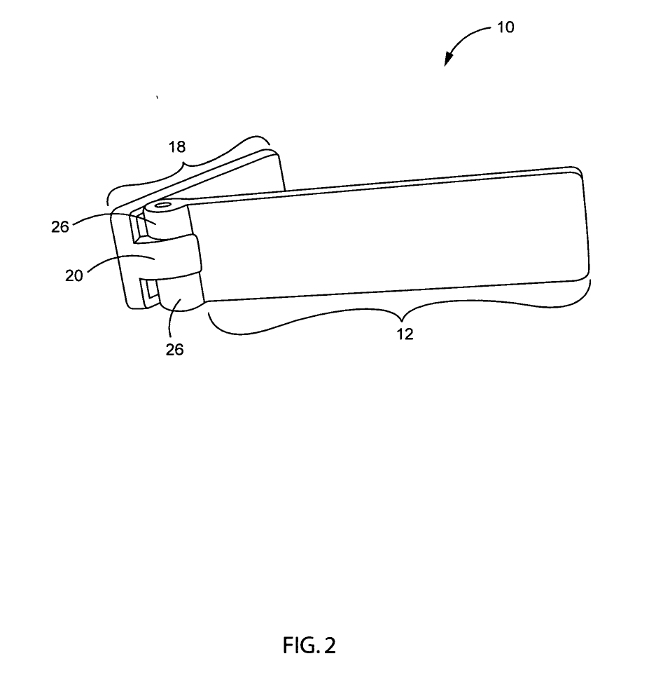

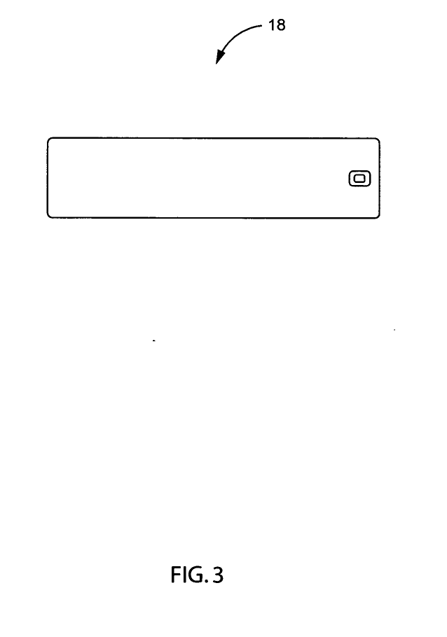

The first portion 12 and the second portion 18 may be formed of a non-conductive material. The second portion 18 may extend substantially perpendicular to the first portion 12 thereby defining an open position when the tool 10 is in use. FIG. 2 illustrates the hinge means 20 utilized for connecting the first portion 12 and the second portion 18. The hinge means 20 may provide a limited opening angle of no more than ninety degrees when the tool 10 is not in use. The first portion 12 and the second portion 18 may swing freely about a vertically hinged axis 26. The first portion 12 and the second portion 18 may be constructed and arranged to provide a flush fit therebetween. FIG. 3 shows a bottom plan view of the second portion 18 of the present invention.

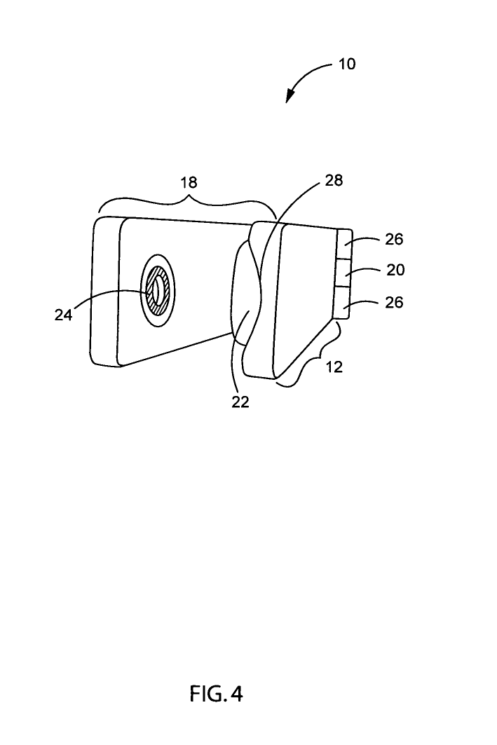

FIG. 4 is a perspective view of the tool 10 in a partially open position, illustrating a notch 28 on the upper end of the first portion 14 and the at least one ferrous portion 24 on the second portion 18. The at least one ferrous portion 24 may be constructed and arranged in alignment with the at least one magnet 22 to provide magnetic securing of the first portion 12 to the second portion 18 thereby defining a closed position. The hinge means 20 allows for motion of the tool 10 along the vertically hinged axis 26 from the closed position to the open position.

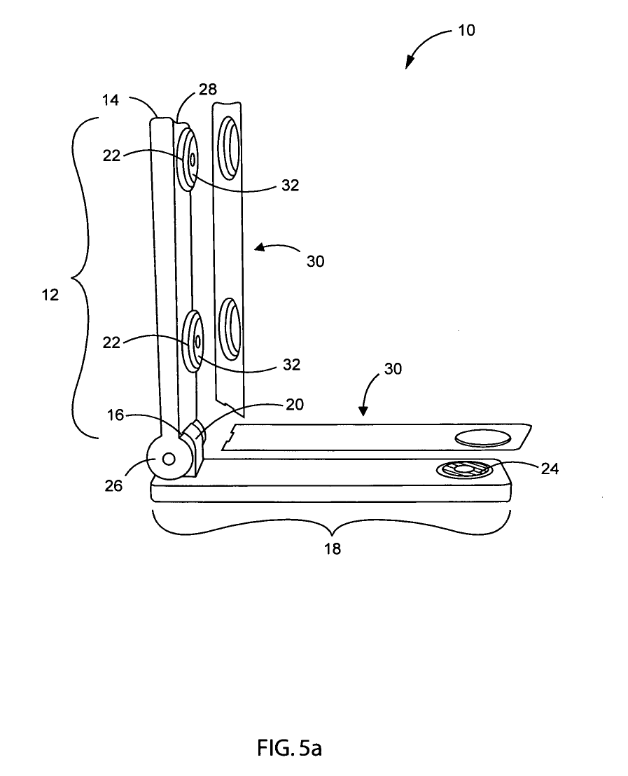

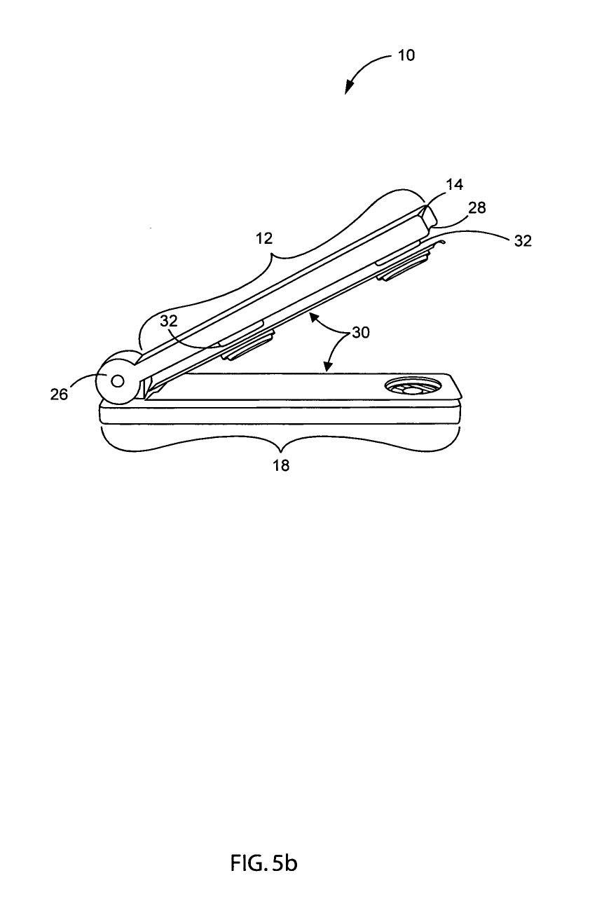

FIG. 5a is an exploded view of the present invention, illustrating a layer of material 30 overlaying the first portion 12 and the second portion 18. The layer of material 30 may be selected from a group consisting of soft rubber and silicone. The layer of material 30 fills the space between the first portion 12 and the second portion 18, as illustrated in FIG. 5b, thereby preventing ferrous objects from getting between the first portion 12 and the second portion 18 when the tool 10 is in the closed position. The layer of material 30 on the first portion 12 encases all sides of the at least one magnet 22 leaving only one flat side 32 exposed. The exposed flat side 32 may be layered with a material selected from a group consisting of soft rubber and silicone to provide a more secure grip to the smooth metal surface of the appliance (not shown). Further, this material may be capable of enhancing mechanical friction grip through pressure applied by the magnetic attraction, decreasing the necessity for more powerful magnets, thereby decreasing cost, while increasing effectiveness.

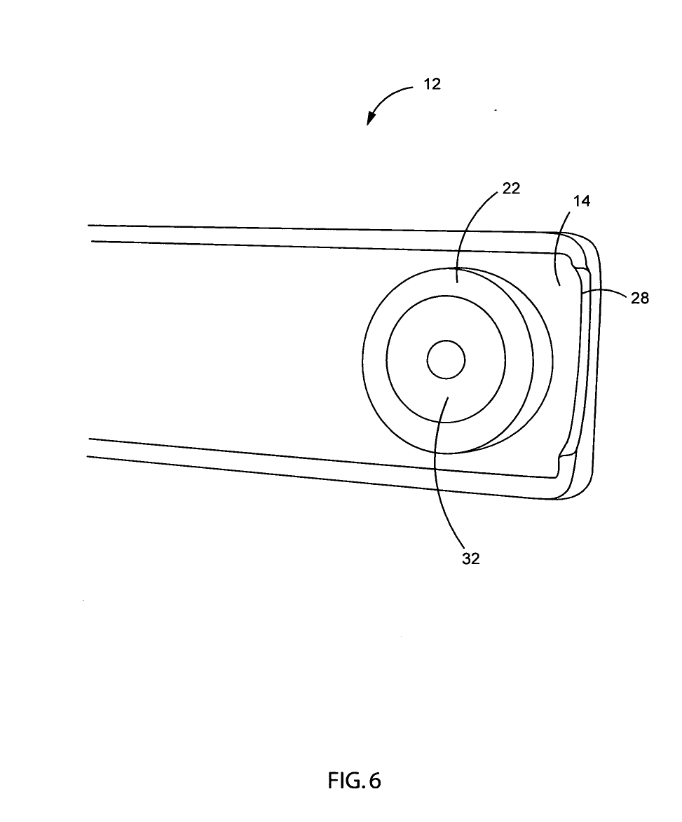

FIG. 6 is an enlarged view of the first portion 12 of the present invention, illustrating the at least one magnet 22 and the notch 28 on the upper end 14. The notch 28 may be formed of size and shape matching the end of a human finger. The notch 28 may be adapted to easily open the tool 10 with one hand. The tool 10 utilizes the at least one magnet 22 to securely fasten and interconnect with the smooth metal surface of the appliance (not shown).

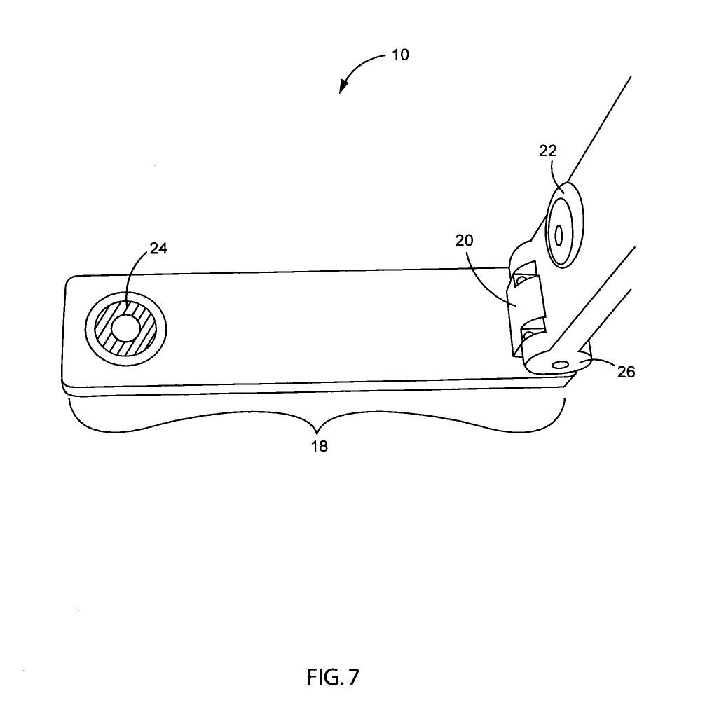

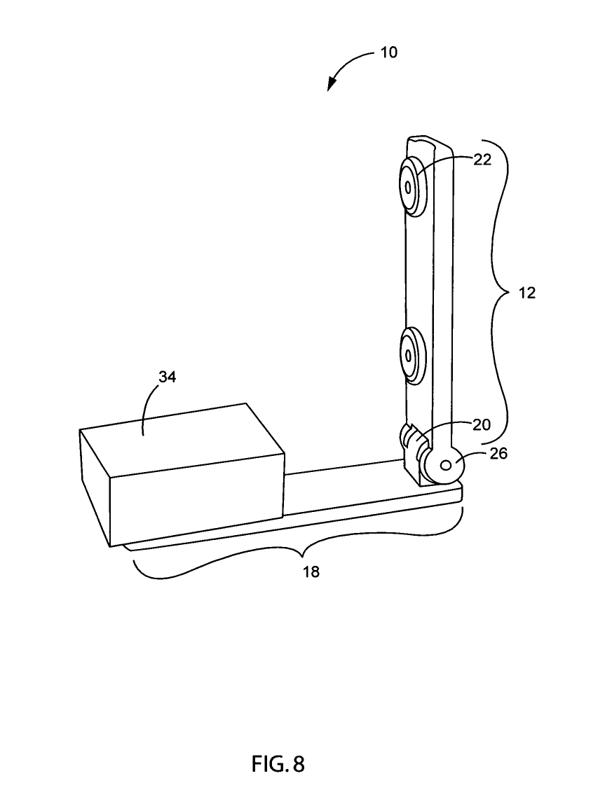

FIG. 7 is a top perspective view of the present invention showing the second portion 18 integrated with the at least one ferrous portion 24 and the hinge means 20. The second portion 18 may be utilized to apply a compression pressure to the safety interlock switch (not shown), thus compressing the switch (not shown). A spacer 34 of desired thickness may be secured to the at least one ferrous portion 24 by a spacer magnet (not shown) to provide maximum compression of the safety interlock switch (not shown) as illustrated in FIG. 8.

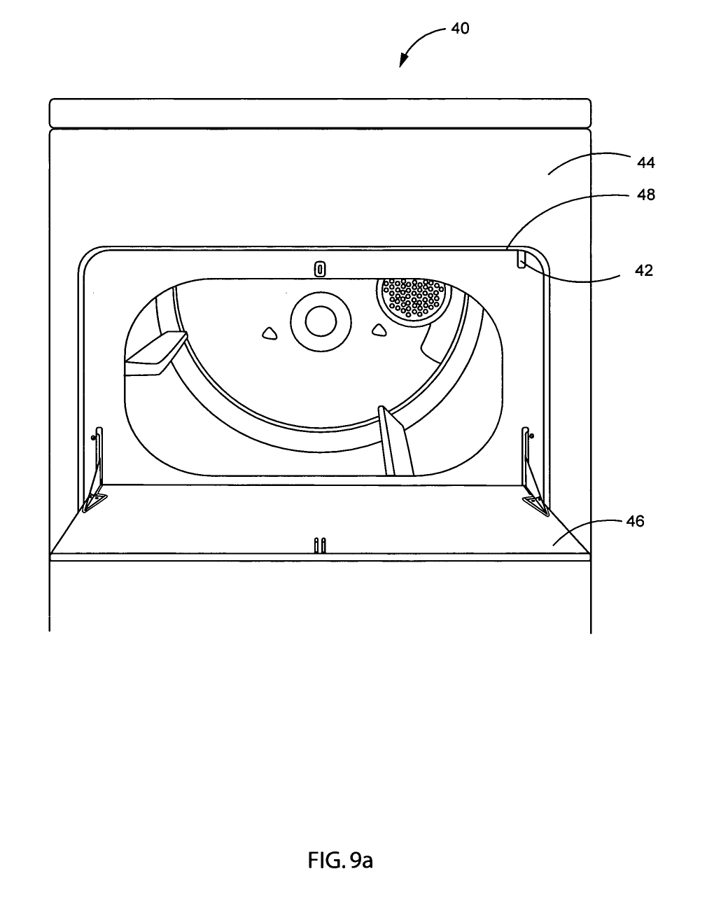

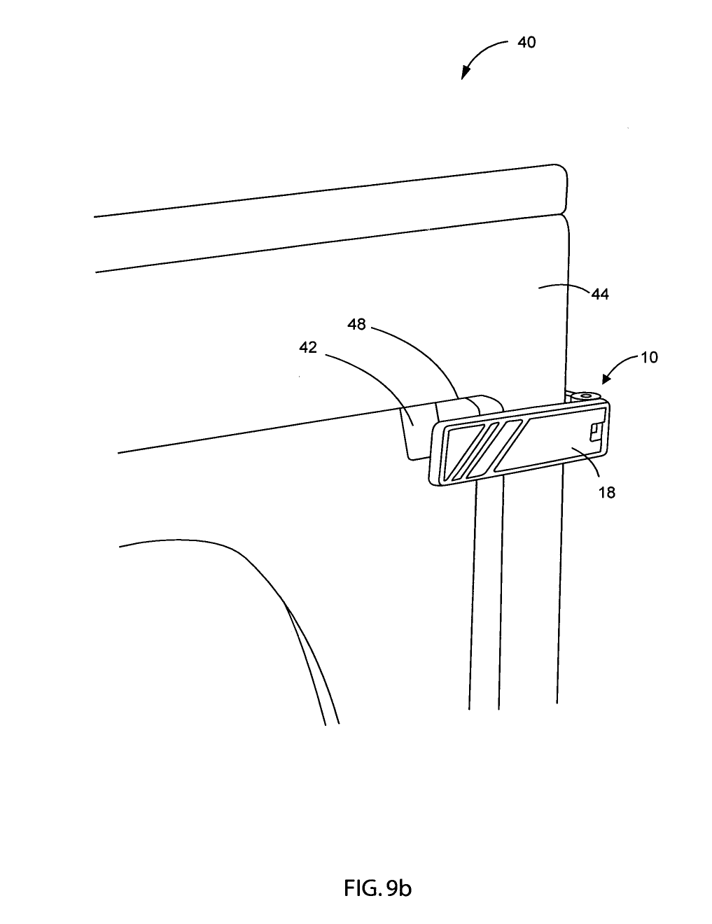

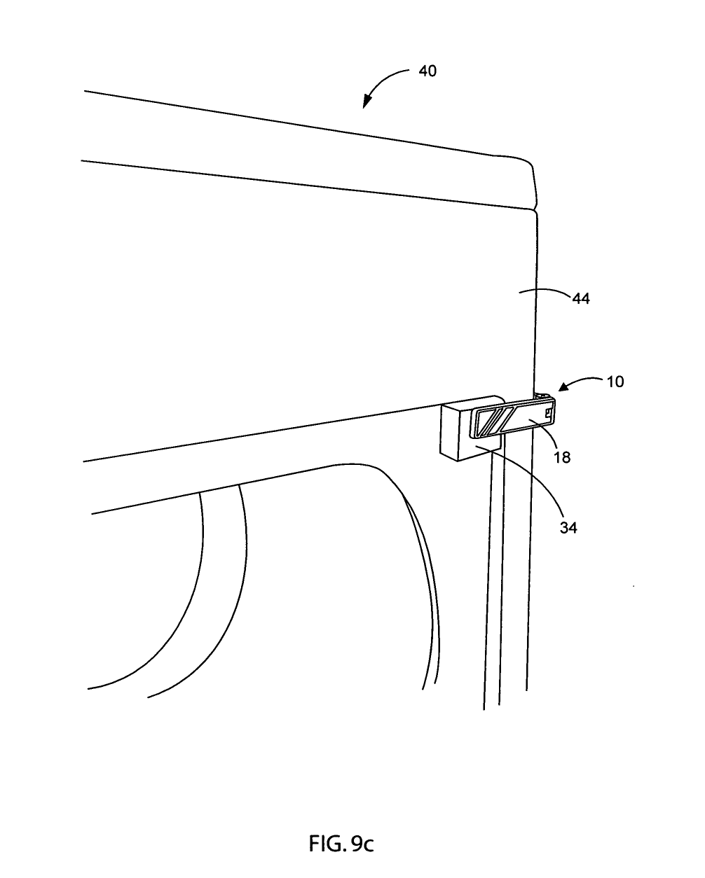

FIG. 9a is a perspective view of a dryer 40 with a safety interlock switch 42 associated with the invention. The dryer 40 may include a containment box 44 having a hinged door 46 and the safety interlock switch 42. The switch 42 may be commonly found disposed ninety degrees from a flat metal side surface of the dryer 48. The switch 42 may be constructed and arranged to be conducting when the hinged door 46 is in the closed position compressing the switch 42, and not conducting when the hinged door 46 is in the open position relaxing the switch 42. The purpose of the safety interlock switch 42 is to shut off the power to the dryer 40 during inspection and cleaning thus protecting the homeowners from electrical shock.

FIG. 9b is a perspective view of the present invention in use with the dryer 40, illustrating the safety interlock switch 42 and the tool 10 magnetically attached onto the dryer 40. The tool 10 of the present invention enables a technician to perform power on diagnostic and repair work. The first portion 12 with the at least one magnet 22 may removably engage with the metal containment box 44 while the second portion 18 secured with the spacer 34 by means of the spacer magnet (not shown) may compress the safety interlock switch 42 as illustrated in FIG. 9c.

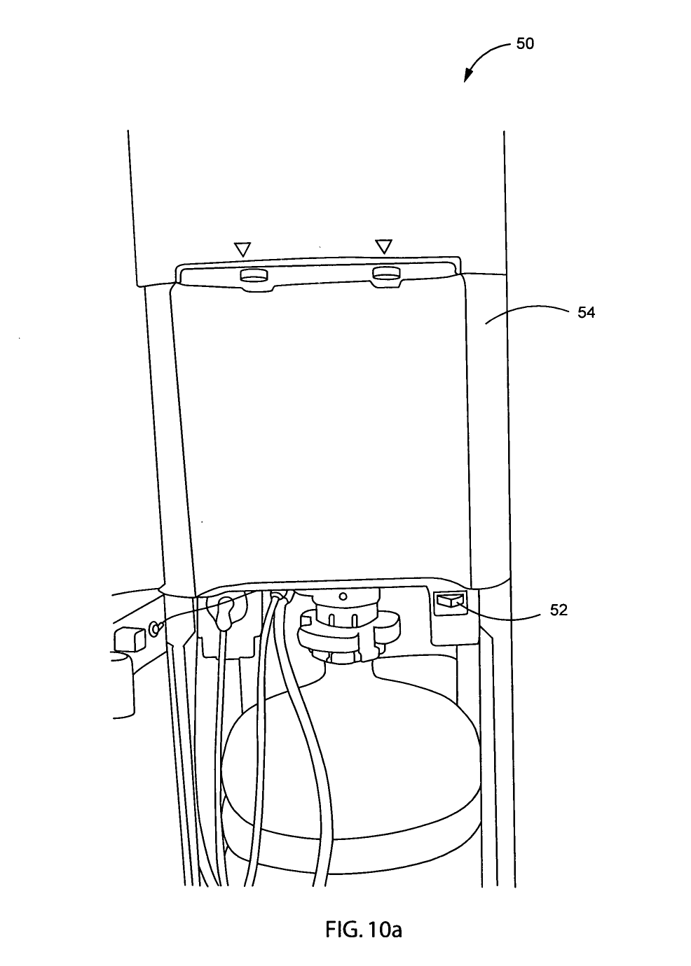

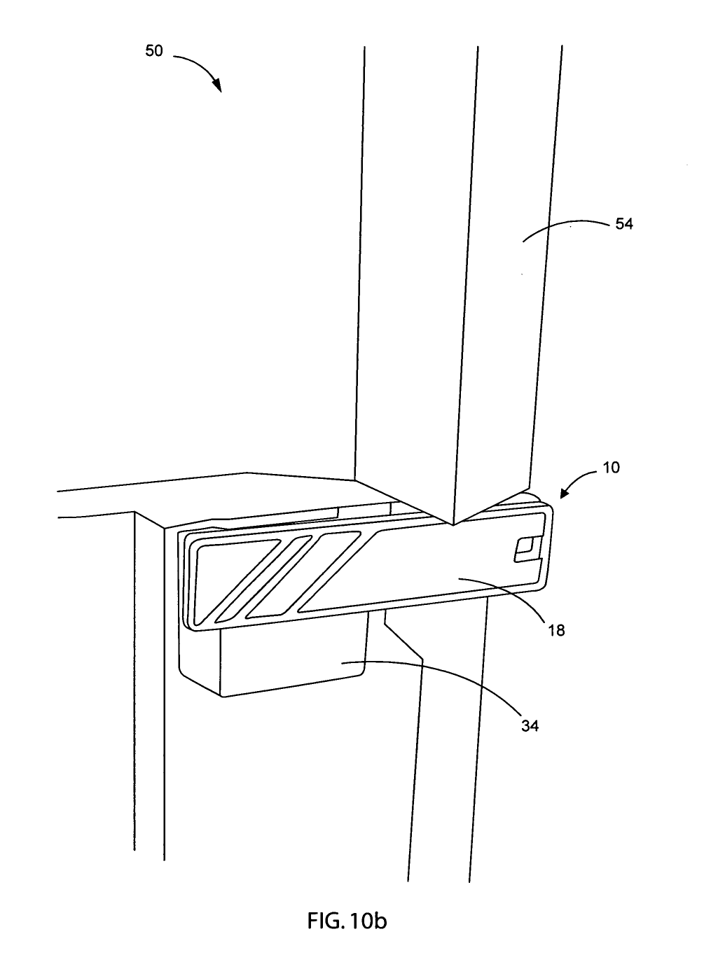

FIG. 10a is a perspective view of a water cooler 50 with a safety interlock switch 52 associated with the invention. The water cooler 50 contains a containment box 54 having a hinged door (not shown) and the safety interlock switch 52. The safety interlock switch 52 may be constructed to shut off the power when the door (not shown) is in an open position and turn on the power when the door (not shown) is in a closed position.

FIG. 10b is a perspective view of the present invention in use with the water cooler 50, illustrating the compression of the safety interlock switch 52 with the tool 10 by means of the spacer 34. While using the tool 10 during maintenance, the at least one magnet 22 secured to the first portion of the tool 12 may magnetically engage with the metal containment box of the water cooler 54. The interlock switch 52 may be compressed with the spacer 34 secured to the second portion 18. With the interlock switch 52 in the compressed position, the water cooler 50 would still have power on to the circuitry facilitating the technician (not shown) to perform diagnostics. The tool 10 may also prevent the inadvertent leaving of the switch 52 compressed by mechanically blocking the door (not shown) from closing.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A tool for compressing a safety interlock switch on an appliance comprising:
a first portion having an upper end and lower end;
a second portion;
a hinge means utilized for connecting the first portion and the second portion;
at least one magnet secured to the first portion; and
at least one ferrous portion integrated within the second portion;
whereby the at least one magnet is configured to fixedly contact with a smooth metal surface of the appliance while compressing the safety interlock switch with the second portion.

2. The tool of claim 1 wherein the first portion and the second portion may be formed of a non-conductive material.

3. The tool of claim 1 wherein in use, the second portion extends substantially perpendicular to the first portion thereby defining an open position.

4. The tool of claim 1 wherein the hinge means may provide a limited opening angle of no more than ninety degrees in the open position.

5. The tool of claim 1 wherein the at least one ferrous portion may be constructed and arranged in alignment with the at least one magnet to provide magnetic securing of the first portion to the second portion thereby defining a closed position.

6. The tool of claim 1 wherein the first portion and the second portion may include a layer of material selected from a group consisting of soft rubber and silicone.

7. The tool of claim 1 wherein the layer of material on the first portion encases all sides of the at least one magnet leaving only one flat side exposed.

8. The tool of claim 7 wherein the exposed flat side may be layered with a material selected from a group consisting of soft rubber and silicone to improve mechanical grip to the smooth metal surface.

9. The tool of claim 1 wherein the upper end may include a notch of size and shape matching the end of a human finger.

10. The tool of claim 9 wherein the notch may be adapted to easily open the tool with one hand.

11. The tool of claim 1 wherein a spacer of desired thickness may be secured to the at least one ferrous portion by a spacer magnet to provide maximum compression of the safety interlock switch.

12. The tool of claim 1 wherein a spacer of desired thickness may be secured to the second portion to provide maximum compression of the safety interlock switch.
